(19) United States
(12) Patent Application Publication
(10) Pub. No.: US 2014/0003188 A1
(43) Pub. Date: Jan. 2, 2014

(54) GAS FLOW CONTROLLER

(71) Applicants: Damien Harding, Clifton Hill (AU); Mark Holdsworth, Draper, UT (US); Diamond Papazoglou, Salt Lake City, UT (US)

(72) Inventors: Damien Harding, Clifton Hill (AU); Mark Holdsworth, Draper, UT (US); Diamond Papazoglou, Salt Lake City, UT (US)

(73) Assignee: TECHNOLOGICAL RESOURCES PTY. LIMITED, Melbourne, Victoria (AU)

(21) Appl. No.: 13/991,322

(22) PCT Filed: Dec. 2, 2011
(86) PCT No.: PCT/AU11/01569

§ 371 Date: Aug. 19, 2013

Related U.S. Application Data
(60) Provisional application No. 61/419,304, filed on Dec. 3, 2010.

(51) Int. Cl. B03D 1/24

(52) U.S. Cl. CPC B03D 1/24
USPC 366/279; 137/624.27; 137/1

(57) ABSTRACT

This invention relates to a flotation gas flow controller for controlling a flow of a flotation gas to a flotation cell that separates valuable minerals from other materials in crushed ore. The gas flow controller includes a valve for controlling gas flow to the cell and a flow meter for monitoring gas flow to the cell via the valve. The flow meter is also for adjusting the valve as required to change the gas flow to meet the gas flow requirements for the cell. The invention also relates to a flotation cell that includes the gas flow controller, a flow control system and a method of controlling gas flow to a flotation cell with a gas flow controller.

### TECHNICAL FIELD

The present invention relates to a froth flotation cell and has particular, although not exclusive application, to a froth flotation cell for extractive metallurgy for separating valuable minerals from other materials in crushed ore.

The invention relates particularly, although by no means exclusively, to a flotation cell that is capable of containing a pulp, such as a slurry of crushed ore, and is equipped with an agitator for introducing a flotation gas into the pulp.

The invention relates particularly, although by no means exclusively, to a flotation gas flow controller for controlling a flow of a flotation gas to a self-aspirating flotation cell.

### BACKGROUND ART

Froth flotation is a process for separating valuable minerals from gangue by taking advantage of hydrophobicity differences between valuable minerals and waste gangue in a feed material. The purpose of froth flotation is to produce a concentrate that has a higher grade, i.e. a higher product grade, of a valuable material (such as copper) than the grade of the valuable material in the feed material. Performance is normally controlled through the addition of surfactants and wetting agents to an aqueous slurry of particles of the minerals and gangue contained in a flotation cell. These chemicals condition the particles and stabilise the froth phase. For each system (ore type, size distribution, water, gas etc), there is an optimum reagent type and dosage level. Once the surface of the solid phases has been conditioned they are then selectively separated with a froth that is created by supplying a flotation gas, such as air, to the process. A concentrate of the minerals is produced from the froth. Like the chemical additives, the separation gas used to generate the froth is a process reagent with an optimum dosage level. The optimum dose of gas is a complex function of many system and equipment factors but for a given flotation cell can be determined empirically by maximising the gas recovery point for the cell.

The performance quality of a flotation process can be measured with respect to two characteristics of a concentrate that is extracted from a flotation cell—namely product grade and product recovery. Product grade indicates the fraction of a valuable material in the concentrate as compared to the remainder of the material in the concentrate. Product recovery indicates the fraction of the valuable material in the concentrate as compared to the total amount of the valuable material in the original feed material that was supplied to the flotation cell.

A key aim of an industrial flotation process is to control operating conditions in order to achieve an optimal balance between grade and recovery, with an ideal flotation process producing high recovery of high grade concentrate.

Until recently, it was thought that grade and recovery were optimised by maximising the supply of flotation gas to the cell. However, studies have since revealed that grade and recovery are improved by optimising flotation gas flow rate to maximise recovery of flotation gas in the froth.

Specifically, International publication WO 2009/044149 in the name of Imperial Innovations Limited relates to an invention of a method of controlling operation of a froth flotation cell that forms part of a froth flotation circuit. The method is based on controlling flotation gas flow rate into a cell so that the cell operates at maximum gas recovery for the cell.

In a situation in which the flotation gas is air, the maximum gas recovery is described as the “peak air recovery” and the air flow rate at the peak air recovery is described as the “peak air rate”.

The paragraph commencing on page 4, line 17 of the International publication defines the term “gas recovery for the cell” to be “a measure of the volume of air or other flotation gas in froth bubbles that overflow from a flotation cell as compared to the volume of air or other flotation gas in bubbles that burst within the cell and/or to the volume of air or other flotation gas introduced into the cell during a flotation process”.

The International publication states that:

“In overview, a method is provided for controlling operation of one or more froth flotation cells. In operation, air or other suitable flotation gas (including gas mixtures), such as nitrogen, is introduced into a froth flotation cell containing a slurry of a liquid and solid particles of an ore (including minerals containing valuable metal to be recovered) in order to create a froth. Overflow of the froth from the cell is then observed from which the air recovery (described above in more general terms as gas recovery) for the cell under the present operating conditions can be measured or inferred by appropriate method. The operation of the cell is controlled by varying the input air flow in order to maximise gas recovery.”

The International publication proposes a number of options for measuring gas recovery. However, significantly in the context of the present invention, the International publication does not disclose how air flow is controlled physically.

### SUMMARY OF THE DISCLOSURE

Test work of the applicant has lead to developments in the manner of controlling flotation gas input to a flotation cell.

Accordingly, there is provided a flotation gas flow controller for controlling a flow of a flotation gas to a self-aspirating flotation cell, the gas flow controller including (a) a valve for controlling gas flow to the cell and (b) a flow meter for measuring gas flow to the cell via the valve and for adjusting the valve as required to change the gas flow to meet the gas flow requirements for the cell.

The gas flow requirements for the cell may include controlling the gas flow rate via the valve so that the cell operates at maximum gas recovery as described in International publication WO 2009/044149.

The expression “measuring gas flow” as used herein is understood to include measurement of flow rate that produces an actual value of the flow rate and measurement that does not produce an actual flow rate value. For example, the output of the measurement may be an indication of whether the flow rate is above or below a set point.

The gas flow controller may comprise a gas flow channel, such as a pipe, for communicating gas from outside the cell to the cell, with the valve being located for controlling gas flow through the gas flow channel.

The gas flow channel may include a section configured to facilitate measuring gas flow through the channel. The section used to measure the gas flow must be designed and configured in accordance with appropriate fluid dynamic principals to obtain an appropriate gas velocity profile in the channel to enable the accurate measurement of bulk gas flow. For those skilled in the art of fluid dynamics this may involve having an appropriate length of straight channel, upstream and downstream of the flow measurement device. Further, in order to avoid long straight sections, flow straightening devices and flow conditions, such as perforated plates, tube bundles, internal tabs or grated plates can be used.

Flow meter manufacturers will recommend various lengths of straight pipe upstream and downstream of the flow meter to attain a fully developed desirable flow profile.

Fluid dynamic principals, therefore, will control the form of the section by taking into account the type of flow meter used to measure gas flow and the type of valve used to control the gas flow.

With this in mind, the section may be substantially straight with the valve located an appropriate distance away from inlet and outlet ends of the section.

Furthermore, the section may include flow meter sensors disposed upstream and/or downstream of the valve. Fluid-dynamic principles will determine the upstream and/or downstream locations of the sensors relative to inlet and outlet ends of the section and relative to the valve in order to obtain accurate gas flow measurements.

According to one embodiment, the section has a length that is at least two times the major cross-sectional dimension of the section upstream and downstream of the valve and the flow meter for flow straightening. In a situation in which the section of the gas flow channel is circular in transverse section, the major cross-sectional dimension is the diameter of the section.

The length of the straight section may be at least 3 times the major cross-sectional dimension of the section upstream and downstream of the valve and the flow meter for flow straightening.

The length of the straight section may be at least 5 times the major cross-sectional dimension of the section upstream and downstream of the valve and the flow meter for flow straightening.

The flotation gas may comprise air or a mixture of air with another gas, such as nitrogen.

It will be appreciated that gas flow into the shaft may not be solely via the gas inlet of the agitator. An amount of uncontrolled air ingress may occur through gaps and holes in the flotation cell. These gaps and holes may arise from corrosion of cell components. However, typically this uncontrolled air ingress is substantially constant so that controlling gas flow through the gas inlet of the agitator largely has the effect of controlling total gas flow into the flotation cell.

The section may comprise a terminal section of the gas flow channel.

The valve may be disposed in a straight section of the gas flow channel. Alternatively, it may be disposed on a free end of the gas flow channel.

The valve may be configured to provide linear control of air flow. Preferably, the valve is an iris valve.

The gas flow controller may include a manifold, such as in the form of a collar, that can be fitted to a self-aspirating flotation cell to communicate gas from outside the cell to a gas inlet of the flotation cell.

The manifold may be formed of two or more parts that are able to be assembled to enclose the gas inlet, whereby gas supply to the gas inlet is at least substantially via the gas flow channel.

The gas flow channel may extend from the manifold to a position where the free end of the channel is accessible by workers from an access platform. The free end may be positioned for workers on the access platform to take gas flow measurements and to adjust the valve.

The gas flow controller may be configured to be contained within the footprint of the flotation cell. For this purpose, the section may be arranged generally vertically.

The gas flow connector may be connected to a gas source for forcing gas into the flotation cell via the gas flow controller.

Such connection enables self-aspirated cells to be converted to forced-gas flotation cells. This is advantageous in the circumstances that “peak air” involves supplying a flotation cell with a gas flow greater than can be achieved through self-aspiration. It is also advantageous because operating a self-aspirating cell with forced-air improves the ability to accurately control the air flow into the cell.

It will be appreciated, therefore, that the gas flow controller can be used to control gas flow into self-aspirating flotation cells and can be used to convert self-aspirating flotation cells into forced-gas flotation cells.

The flow meter may be linked to a flow control system that adjusts the valve by reference to data obtained from the flow meter and to a predetermined gas flow.

There is also provided a flotation cell for generating a froth loaded with a valuable mineral component from a pulp containing valuable and non-valuable mineral components, the flotation cell including the above-described gas flow controller for controlling the flow of a flotation gas to the cell.

The flotation cell may further include:
(a) a tank for containing a volume of the pulp;
(b) an agitator for stirring the pulp and introducing a flotation gas into the pulp, the agitator having a shaft extending into the tank and an impeller in gas communication with the shaft and configured to disperse gas into the pulp, and the agitator having a gas inlet for communicating gas outside the tank to within the shaft for communication to the impeller; and
(c) a driving mechanism connected to the impeller to cause the impeller to rotate and, in use, to disperse gas in the pulp.

There is also provided a flow control system for controlling gas-flow to one or more flotation cells described above, wherein the flow control system adjusts the valve to control gas flow in the gas flow channel in response to the measured gas flow to the cell to meet the gas flow requirements for the cell.

The flow control system may adjust the valve to control gas flow by (a) receiving gas-flow data from flow meters of one or more flotation cells, (b) comparing the data to a predetermined gas-flow and (c) sending a control signal to the valve of the or each flotation cell to adjust the valve so that the gas-flow is substantially the same as the predetermined gas-flow.

There is also provided a method of controlling gas flow to a self-aspirating flotation cell for generating froth loaded with a valuable mineral component from a pulp containing valuable and non-valuable mineral components, the flotation cell comprising a tank for containing a volume of the pulp, an agitator for stirring the pulp a driving mechanism for driving the agitator, and a gas flow controller for controlling gas flow to the cell the gas flow controller including (a) a valve for controlling gas flow to the cell and (b) a flow meter for measuring gas flow to the cell via the valve and for adjusting the valve as required to change the gas flow to meet the gas flow requirements for the cell, the method comprising the steps of:
(a) fitting the gas flow controller to the flotation cell
(b) measuring gas flow to the cell via the valve; and
(c) adjusting the valve to control gas flow in the gas flow channel in response to the measured gas flow to the cell to meet the gas flow requirements for the cell.

The gas flow requirements of the cell may include controlling the gas flow rate via the valve so that the cell operates at maximum gas recovery as described in International publication WO 2009/044149.

There is also provided a flow control kit for controlling flow of flotation gas to a self-aspirated flotation cell, the kit including:
(a) a manifold that can be fitted to a cell to communicate gas from outside the cell to a gas inlet of the flotation cell;
(b) a valve for controlling gas flow through the manifold to the cell; and
(c) a flow meter for monitoring gas flow to the cell via the valve.

The flow control kit may include a gas source for forcing gas to the flotation cell via the valve.

### BRIEF DESCRIPTION OF THE DRAWINGS

An embodiment of the flotation cell and gas flow controller of the present invention is now described by reference to the accompanying drawings, of which:

FIG. 1 is a side elevation of a flotation cell fitted with a gas flow controller for admitting air to the cell according to an embodiment;

FIG. 2 is a top plan view of the flotation cell in FIG. 1 with the agitator drive mechanism removed to make it easier to view other components of the cell;

FIG. 3 is cross-section along the line 2-2 in FIG. 2;

FIG. 4 is a diagram of one embodiment of a gas flow control system for the gas flow controller; and

FIG. 5 is a side elevation of a flotation cell fitted with a gas flow controller for admitting air to the cell according to another embodiment.

### DESCRIPTION OF EMBODIMENT

The following description of a gas flow controller according to an embodiment of the invention is in the context of an air-based froth flotation process for separating valuable copper minerals from low value gangue materials. It will be appreciated, however, that gas flow controllers according to the invention can be used with other flotation gases and in froth flotation processes for separating other valuable materials from low-value materials and in other processes where gas flow control is important to the outcome of the process.

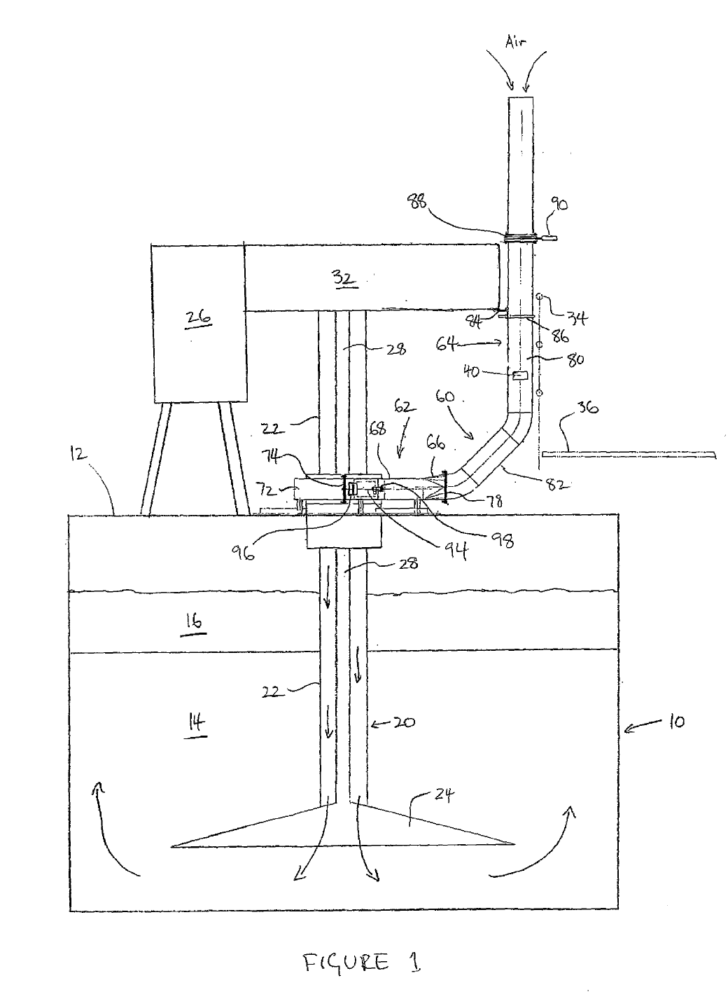

A typical froth flotation cell shown in FIG. 1 is fitted with a gas flow controller in the form of an air flow controller generally identified by the numeral 60.

The flotation cell comprises a tank 10 for containing a volume of a pulp 14 and an agitator generally identified by the numeral 20 for stirring the pulp 14 and introducing air into the pulp 14.

The flotation cell further comprises a drive mechanism in the form of an electric motor 26 coupled by a driving belt (not shown—housed inside a drive mechanism cover 32) to a drive shaft 28 of the agitator 20.

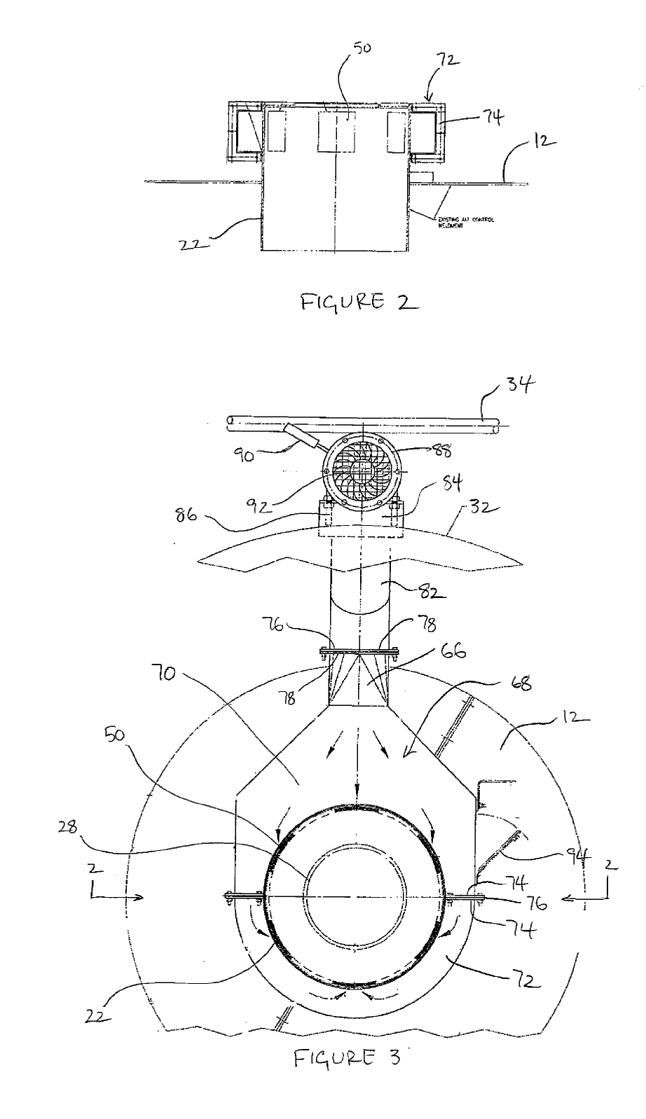

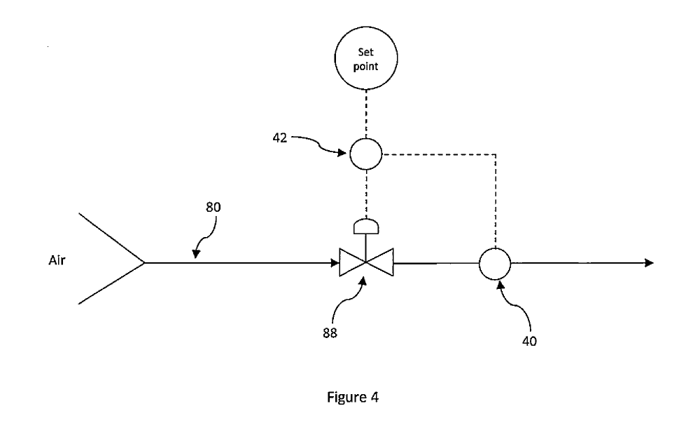

The agitator 20 includes an outer shaft 22 extending downwardly from the drive mechanism through a roof 12 of the tank 10 and into the pulp 14. The drive shaft 28 extends generally centrally downwardly through the shaft 22 so that an annular air space exists between the shaft 22 and the drive shaft 28. The shaft 22 includes apertures 50 (FIG. 2) located outside the tank 10, in this case slightly above the roof 12.

The drive shaft 28 is connected at a lower end to an impeller 24 shown schematically in FIG. 1. The impeller 24 is a further component of the agitator 20. The impeller 24 is designed to stir the pulp 14 and, in doing so, draw air downwardly through the air gap for dispersion by the impeller in the pulp 14 as bubbles. Hence, the described arrangement is a self-aspirating cell.

The pulp 14 comprises a slurry of water and finely crushed particles of copper ore. Typically, the chemical conditions in the pulp 14 are controlled so that particles of valuable copper minerals interact with and attach to bubbles of introduced air in the pulp 14 and float to the surface of the pulp 14 to form a froth 16 loaded with particles of valuable copper mineral. The chemical conditions of the pulp are controlled to make non-valuable minerals inert to oxygen so that those minerals stay within the pulp 14 and are removed during the flotation process. The froth 16 is removed and subjected to downstream processing to recover the valuable copper minerals and eventually copper metal.

The air flow controller comprises a manifold 62, an air flow channel in the form of a pipe 64 that communicates air from the atmosphere to the apertures 50, and a valve 88 that controls the flow of air through the pipe 64.

During normal operation, with the cell operating as a self-aspirating cell, air flow to the impeller 24 is induced by rotation of the impeller 24. The air flow proceeds from the atmosphere into the pipe 64, through the valve 88 and then into the manifold 62. The air flow then enters the air gap between the shaft 22 and the drive shaft 28 and proceeds to the impeller 24. The air flow is indicated by the arrows in FIG. 1.

Referring to FIGS. 1 and 2, the manifold 62 is positioned to enclose the section of the shaft 22 that includes the apertures 50. The manifold 62 comprises a forward portion 70 and a rearward portion 72.

The forward portion 70 has a neck section 66 that terminates in a flange 78 to facilitate connection of the manifold 62 to the pipe 64. The forward portion 70 also includes a distributor section 68 in which air entering via the neck section 66 spreads throughout the distributor section 68 to provide a generally uniform flow of air to the apertures 50 spaced about the shaft 22.

A rearward end of the forward portion 70 includes a flange 74 to facilitate connection with the rearward portion 72 which also includes a flange 74 at a forward section. A gasket 76 is located between the flanges 74 to form a generally air-tight seal between the forward section 70 and rearward section 72 when the manifold 62 is fitted to the shaft 22. The gasket may be formed of any suitable rubberised material, including neoprene.

An edge of the forward portion 70 and the rearward portion 72 that comes into contact with the shaft 22 includes an upstanding wall (not shown) which is generally parallel to the outer surface of the shaft 22 and also includes a gasket (not shown) of a suitable material so that when the manifold 62 is fitted to the shaft 22 a generally air-tight seal is formed.

The forward portion 70 includes an inspection hatch 94 that is attached to a sidewall of the manifold 62 by a hinge 96 at one end and a releasable latch 98 at an opposite end. The inspection hatch 94 enables a quick assessment of conditions inside the manifold 62 without the need of removing the manifold 62 from the shaft 22.

It will be appreciated that the manifold 62 is able to be retro-fitted to a self-aspirated flotation cell to enable control over the gas flow into the cell. It also enables self-aspirated flotation cells to be converted to a forced-gas flotation cell by connecting the air flow controller 60 to a source of gas. In this manner, the cell may be supplied with an amount of gas that is greater than the amount supplied under normal self-aspirating operating conditions. That is to say the gas source provides gas at a pressure above atmospheric pressure. The gas source may be any form of pressurized gas including, but not limited to, a source 100 of compressed air source or fan-forced air. This embodiment is shown in FIG. 5 with the like features denoted with like reference numerals and with the source 100 shown schematically as a unit remote from the cell which draws in air and then supplies it at an elevated air pressure to the cell. However, it will be appreciated that the source 100 may supply compressed air source or fan-forced air to multiple cells.

The pipe 64 includes an elbow section 82 which may comprise a single bend or multiple bends (two bends shown in FIG. 1) and a straight section 80 extending generally upwardly from the elbow section 82.

The straight section 80 is supported in the generally vertical orientation by a plate 84 which is affixed to the drive mechanism cover 32 and a U-bolt 86 which passes around the straight section 80 and is fastened to the plate 84.

The pipe 64 is designed to extend upwardly alongside a worker platform in the form of a catwalk 36 and accompanying handrail 34 so that the valve 88 is readily accessible.

The length of the straight section 80 ensures that gas-flow measurements taken by flow meter 40 are accurate and therefore proper adjustment of the valve 88 is made. However, the length of the section 80 and the positions of the valve 88 and the flow meter 40 are determined by fluid-dynamic principles to ensure accurate gas-flow measurements can be obtained. Accordingly, the lengths and positions will vary depending on the type of valve 88 and the type of gas flow meter 40. The reason for this is that bends in the pipe 64 affect the gas-flow profile within the pipe 64. Additionally interference from obstructions in the pipe 64, for example, the valve 88 and the flow meter 40, also affect the gas-flow profile. This is important to understand because different gas flow measurements will be obtained from different points in the gas-flow profile. Straight sections of pipe enable a relatively uniform profile to be restored and, therefore, enable accurate measurements to be taken.

The applicant has particularly found that the straight section 80 should have a length of at least five times the diameter of the pipe 64 before and after the valve 88. However alternative lengths may be sufficient and it should be understood that the invention is not limited to lengths before and after the valve 88 that are five times the diameter of the pipe 64.

Vertical arrangement of the straight section 80 is advantageous because it ensures that the pipe 64 stays within the footprint of the tank 10 to avoid interference with adjacent tanks. Furthermore, the vertical arrangement results in the open end of the straight section 80 being around chest-level of a worker 38. This is a convenient location because it avoids workplace hazards associated with placing the open end of the straight section 80 at or slightly above the catwalk 36 or even away from the catwalk 36 closer to the shaft 22.

The valve 88 is in the form of an iris valve. A mesh 92 covers the opening of the pipe 64 to prevent objects from entering the air flow controller 60 that, if passed through the pipe 64 and into the shaft 22, may damage the impeller or other parts of the flotation cell.

Air flow control to the tank 10 is controlled by adjusting the valve 88 which provides linear adjustment control over flow rates of air through the valve 88. The linear adjustment is important for accurate control of air flow in order to achieve maximum air recovery in the froth 16.

In one form of operation, air flow measurements are taken by a worker with a hand-held flow meter by inserting a probe into the pipe 64 downstream of the valve 88. The air flow measurements are used to adjust the valve 88 to obtain a desired air flow to the impeller 24. For example, the desired air flow may be air flow that ensures that the cell operates at maximum air recovery as described in International publication WO 2009/044149. The desired air flow may be predetermined so that adjustments can readily be made manually by a worker at the time of taking an air flow measurement.

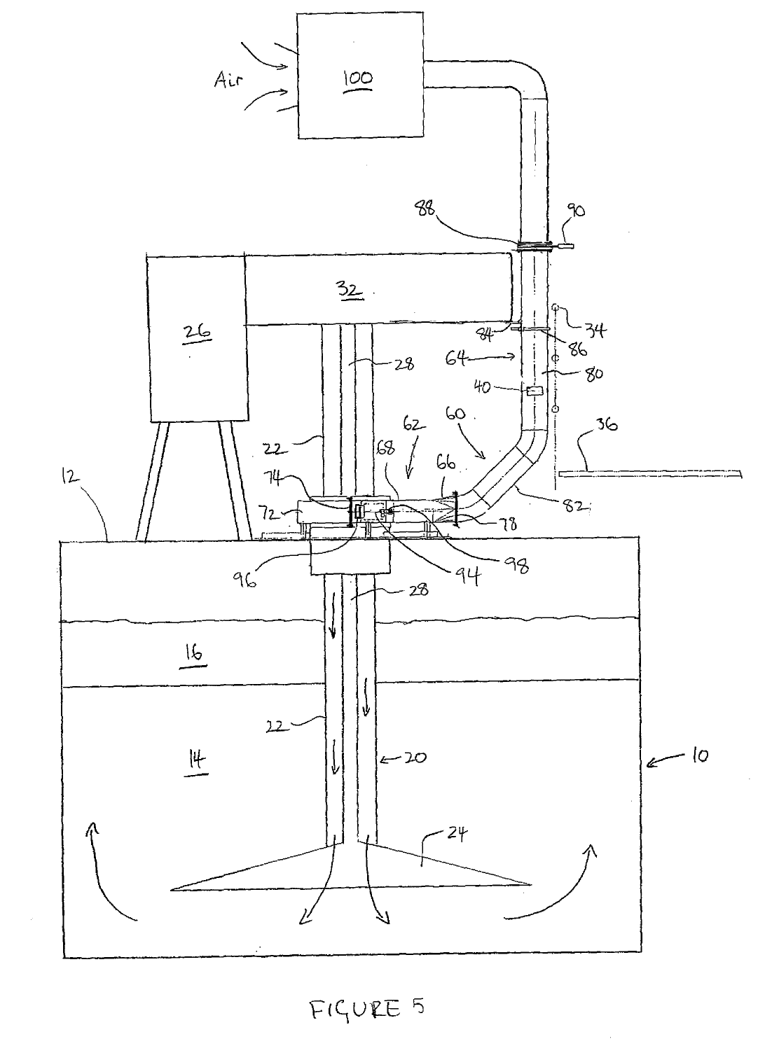

Alternatively, adjustments to the air flow may be made automatically via a flow control system. For example, with reference to FIG. 4, data from the flow meter 40 may be input to a flow control system 42 that compares the inputted data against a set point for air flow and adjusts the valve 88 to the set point. One of the main factors that will impact the set point for air flow is peak air recovery. In other words, the set point will be selected so the cell operates at or close to peak air recovery. It will be appreciated that air recovery is affected by variable conditions within the cell, including: the volume of slurry in the flotation cell, the solids loading of the slurry, the concentration of froth-forming agents in the slurry, the pressure and/or density of gas being supplied to the cell, the position of the flotation cell in a flotation circuit and the mineralogical composition of solids in the slurry.

Data sent to the flow control system 42 may be obtained by manual or automatic sampling and may be obtained by continuous or periodic sampling.

In any situation, the desired air flow will depend on conditions in the tank 10, such as solids loading of the pulp 14.

The air flow controller 60 can be fitted to each flotation cell in a flotation circuit. Accordingly, the air flow to each cell can be optimised to account for the conditions at each stage of a flotation circuit in each cell. This is particularly advantageous because the conditions in rougher, scavenger, and cleaner cells in a circuit are different. Therefore, the air flow can be customised to the prevailing conditions in groups of flotation cells to optimise grade and recovery. Similarly, the air flow to each cell in a group of rougher cells can be adjusted independently to optimise flotation conditions. The same applies to each cell in the scavenger and cleaner cell groups to improve recovery and grade across all the flotation cells in a circuit.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Many modifications may be made to the preferred embodiment of the present invention as described above without departing from the spirit and scope of the present invention.

By way of example, whilst the drawings disclose a flotation cell that is self-aspirating in that rotation of the impeller 24 induces air flow into the cell, the present invention is not so limited and extends to arrangements in which the air flow is a forced air flow.

By way of further example, whilst the drawings disclose a self-aspirating flotation cell in which air is introduced into the cell via the agitator of the cell, the present invention is not so limited and extends to any other suitable options for self-aspirating the cell.

1. A flotation gas flow controller for controlling a flow of a flotation gas to a self-aspirated flotation cell, the gas flow controller including (a) a valve for controlling gas flow to the cell and (b) a flow meter for monitoring gas flow to the cell via the valve and for adjusting the valve as required to change the gas flow to meet the gas flow requirements for the cell.

2. The gas flow controller defined in claim 1, wherein the gas flow controller comprises a gas flow channel for communicating gas from outside the cell to the cell, with the valve being located for controlling gas flow through the gas flow channel.

3. The gas flow controller defined in claim 2, wherein the gas flow channel includes a section configured to facilitate measuring gas flow through the channel,

4. The gas flow controller defined in claim 3 wherein the section of the gas flow controller that is configured to facilitate measuring gas flow is substantially straight.

5. The gas flow controller defined in claim 1, wherein the gas flow controller includes a manifold that can be fitted to a self-aspirating flotation cell to communicate gas from outside the cell to a gas inlet of the flotation cell.

6. The gas flow controller defined in claim 5, wherein the manifold is formed of two or more parts that are able to be assembled to enclose gas inlets of a flotation cell, whereby gas supply to the gas inlets is at least substantially via the gas flow controller.

7. The gas flow controller defined in claim 1, wherein the valve is configured to provide linear control of air flow.

8. The gas flow controller defined in claim 6, wherein the valve is an iris valve.

9. The gas flow controller as defined in claim 1, wherein the gas flow controller is connectable to a gas source for forcing gas into the flotation cell via the gas flow controller.

10. The gas flow controller as defined in claim 1, wherein the flow meter is able to be linked to a flow control system that adjusts the valve by reference to data obtained from the flow meter and to a predetermined gas flow.

11. A flotation cell for generating a froth loaded with a valuable mineral component from a pulp containing valuable and non-valuable mineral components, the flotation cell including the gas flow controller as defined in claim 1.

12. The flotation cell defined in claim 11, wherein the flotation cell further includes:
(a) a tank for containing a volume of the pulp;
(b) an agitator for stirring the pulp and introducing a flotation gas into the pulp, the agitator having a shaft extending into the tank and an impeller in gas communication with the shaft and configured to disperse gas into the pulp, and the agitator having a gas inlet for communicating gas outside the tank to within the shaft for communication to the impeller; and
(c) a driving mechanism connected to the impeller to cause the impeller to rotate and, in use, to disperse gas in the pulp.

13. The flotation cell defined in claim 11, wherein the gas flow controller is connected to a gas source for forcing gas into the flotation cell via the gas flow controller.

14. The flotation cell defined in claim 11, wherein the flow meter is linked to a flow control system that adjusts the valve by reference to data obtained from the flow meter and to a predetermined gas flow.

15. A flow control system for controlling gas-flow to one or more flotation cells according to the flotation cell defined in claim 11, wherein the flow control system adjusts the valve to control gas flow in the gas flow channel in response to the measured gas flow to the cell to meet the gas flow requirements for the cell.

16. The flow control system defined in claim 13, wherein adjustment of the valve to control gas flow involves (a) receiving gas-flow data from flow meters of one or more flotation cells, (b) comparing the data to a predetermined gas-flow and (c) sending a control signal to the valve of the or each flotation cell to adjust the valve so that the gas-flow is substantially the same as the predetermined gas-flow.

17. A method of controlling gas flow to a flotation cell for generating froth loaded with a valuable mineral component from a pulp containing valuable and non-valuable mineral components, the flotation cell comprising a tank for containing a volume of the pulp, an agitator for stirring the pulp, a driving mechanism for driving the agitator and a gas flow controller, the gas flow controller including (a) a valve for controlling gas flow to the cell and (b) a flow meter for measuring gas flow to the cell via the valve and for adjusting the valve as required to change the gas flow to meet the gas flow requirements for the cell, the method comprising the steps of:
(a) fitting the gas flow controller to the flotation cell
(b) measuring gas flow to the cell via the valve; and
(c) adjusting the valve to control gas flow in the gas flow channel in response to the measured gas flow to the cell to meet the gas flow requirements for the cell.

18. A flow control kit for controlling flow of flotation gas to a self-aspirated flotation cell, the kit including:
(a) a manifold that can be fitted to a cell to communicate gas from outside the cell to a gas inlet of the flotation cell;
(b) a valve for controlling gas flow through the manifold to the cell; and
(c) a flow meter for monitoring gas flow to the cell via the valve.
